(19) United States
(12) Patent Application Publication
(10) Pub. No.: US 2020/0269600 A1
(43) Pub. Date: Aug. 27, 2020

(54) IMAGE FORMING APPARATUS

(71) Applicant: ALPS ALPINE CO., LTD., Tokyo (JP)

(72) Inventors: Akira YANAGIDA, Miyagi (JP); Yoshibumi ABE, Miyagi (JP); Kazuhiro HONDA, Miyagi (JP); Teru NISHIYAMA, Miyagi (JP); Masahiko KITAMURA, Tokyo (JP)

(21) Appl. No.: 15/931,933

(22) Filed: May 14, 2020

Related U.S. Application Data
(63) Continuation of application No. PCT/JP2018/035919, filed on Sep. 27, 2018.

(30) Foreign Application Priority Data
Nov. 15, 2017 (JP) 2017-220373

(51) Int. Cl. B41J 2/335; B41J 11/057; B41J 15/04; B41J 25/312

(52) U.S. Cl. CPC B41J 2/335; B41J 11/057; B41J 2202/31; B41J 25/312; B41J 15/04

(57) ABSTRACT

An image forming apparatus includes a frame, a platen roller rotatably supported by the frame, a thermal head that is provided to face the platen roller, and a supporting unit that supports the thermal head from above, wherein the supporting unit includes an adjustment part that can adjust a height of the supporting unit by an adjuster, and the supporting unit can adjust an angle of the thermal head by adjusting the height of the adjustment part by the adjuster with at least a portion of the supporting unit being deformed, and wherein the supporting unit can adjust the height of the adjustment part by adjusting a protrusion amount of the adjuster with a tip of the adjuster being butted against the frame.

### CROSS-REFERENCE TO RELATED APPLICATION

This application is a continuation application of International Application No. PCT/JP2018/035919 filed on Sep. 27, 2018, and designated the U.S., which is based upon and claims priority to Japanese Patent Application No. 2017-220373, filed on Nov. 15, 2017, the entire contents of which are incorporated herein by reference.

### BACKGROUND OF THE INVENTION

### 1. Field of the Invention

The present disclosure relates to an image forming apparatus.

### 2. Description of the Related Art

Thermal printers have been employing a configuration in which an image is formed on a thermal paper by heating the thermal paper by heating elements provided in a thermal head in a state that the thermal paper is interposed between the thermal head and a platen roller, so that the thermal paper is pressed against the thermal head.

In the thermal printer with such a configuration, quality of an image formed on the thermal paper can be improved by adjusting an angle of the thermal head to an appropriate angle. Thus, with respect to the thermal printer, a technique that can adjust the angle of the thermal head has been disclosed.

For example, Patent Document 1 discloses a technique that can adjust the angle of the thermal head by adjusting an angle of a second bracket with respect to a first bracket that is attached to a printer body and that can be opened and closed, and to which the second bracket with the thermal head is rotatably attached.

### RELATED-ART DOCUMENTS

### Patent Document

Patent Document 1: Japanese Laid-Open Patent Publication No. 2013-216041

### SUMMARY OF THE INVENTION

According to one aspect of an embodiment, an image forming apparatus includes a frame, a platen roller rotatably supported by the frame, a thermal head that is provided to face the platen roller, and a supporting unit that supports the thermal head from above, wherein the supporting unit includes an adjustment part that can adjust a height of the supporting unit by an adjuster, and the supporting unit can adjust an angle of the thermal head by adjusting the height of the adjustment part by the adjuster with at least a portion of the supporting unit being deformed, and wherein the supporting unit can adjust the height of the adjustment part by adjusting a protrusion amount of the adjuster with a tip of the adjuster being butted against the frame.

### BRIEF DESCRIPTION OF THE DRAWINGS

FIG. 1 is a perspective view illustrating an appearance of a thermal printer according to a first embodiment;

FIG. 2 is a plan view of the thermal printer according to the first embodiment;

FIG. 3 is a side view of the thermal printer according to the first embodiment;

FIG. 4 is a front view of the thermal printer according to the first embodiment;

FIG. 5 is a cross-sectional view of the thermal printer illustrated in FIG. 1 taken along the line A-A;

FIG. 6A is a drawing for describing an operation of adjusting an angle of a thermal head in the thermal printer according to the first embodiment;

FIG. 6B is a drawing for describing an operation of adjusting the angle of the thermal head in the thermal printer according to the first embodiment;

FIG. 7 is a partially enlarged view of a part screwed by a fixing screw in the thermal printer according to the first embodiment;

FIG. 8 is a perspective view illustrating an appearance of a thermal printer according to a second embodiment;

FIG. 9 is a plan view of the thermal printer according to the second embodiment;

FIG. 10 is a side view of the thermal printer according to the second embodiment;

FIG. 11 is a front view of the thermal printer according to the second embodiment;

FIG. 12A is a drawing for describing an operation of adjusting an angle of a thermal head in the thermal printer according to the second embodiment;

FIG. 12B is a drawing for describing an operation of adjusting the angle of the thermal head in the thermal printer according to the second embodiment;

FIG. 13 is a perspective view illustrating an appearance of a thermal printer according to a third embodiment;

FIG. 14 is a plan view of the thermal printer according to the third embodiment;

FIG. 15 is a side view of the thermal printer according to the third embodiment;

FIG. 16 is a front view of the thermal printer according to the third embodiment;

FIG. 17A is a drawing for describing an operation of adjusting an angle of a thermal head in the thermal printer according to the third embodiment;

FIG. 17B is a drawing for describing an operation of adjusting the angle of the thermal head in the thermal printer according to the third embodiment;

FIG. 18A is a drawing for schematically describing an operation of adjusting the angle of the thermal head in the thermal printer according to the first embodiment; and

FIG. 18B is a drawing for schematically describing an operation of adjusting the angle of the thermal head in the thermal printer according to the first embodiment.

### DESCRIPTION OF THE PREFERRED EMBODIMENTS

The technique of Patent Document 1 requires a configuration in which the thermal head is rotatably supported in order to adjust an angle of the thermal head. Thus, the technique of Patent Document 1 might increase a cost and decrease reliability of a product because a configuration for adjusting the angle of the thermal head becomes relatively complicated. Therefore, an image forming apparatus that can achieve an angle adjustment of the thermal head with a relatively simple configuration, is desired.

### First Embodiment

In the following, a first embodiment will be described with reference to the drawings.

(Basic Configuration of a Thermal Printer 100)

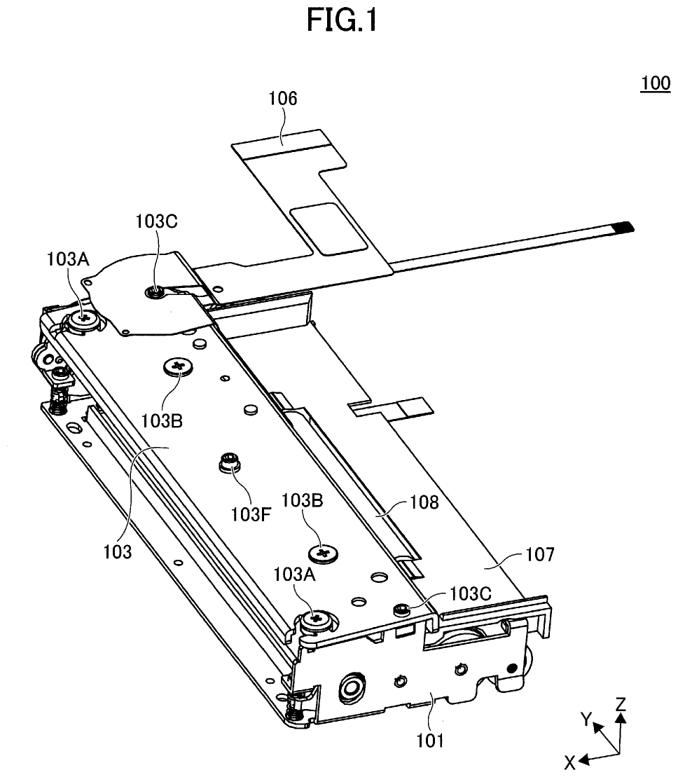

First, a basic configuration of a thermal printer 100 according to a first embodiment will be described with reference to FIGS. 1 to 5.

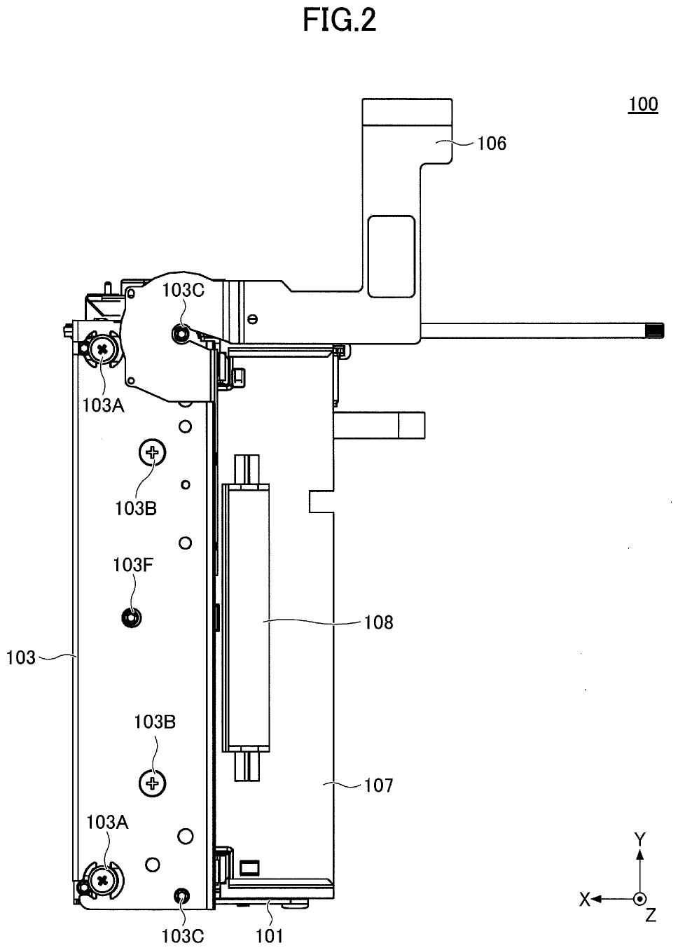

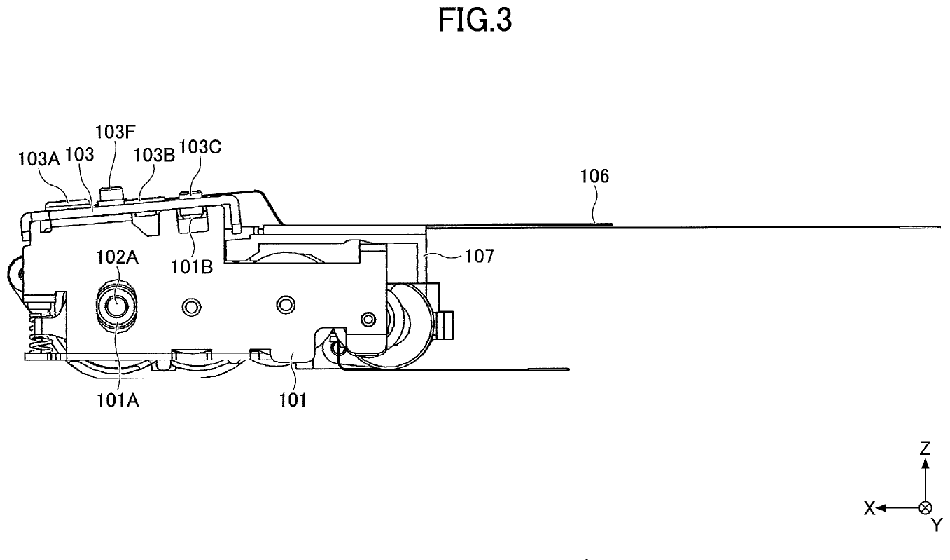

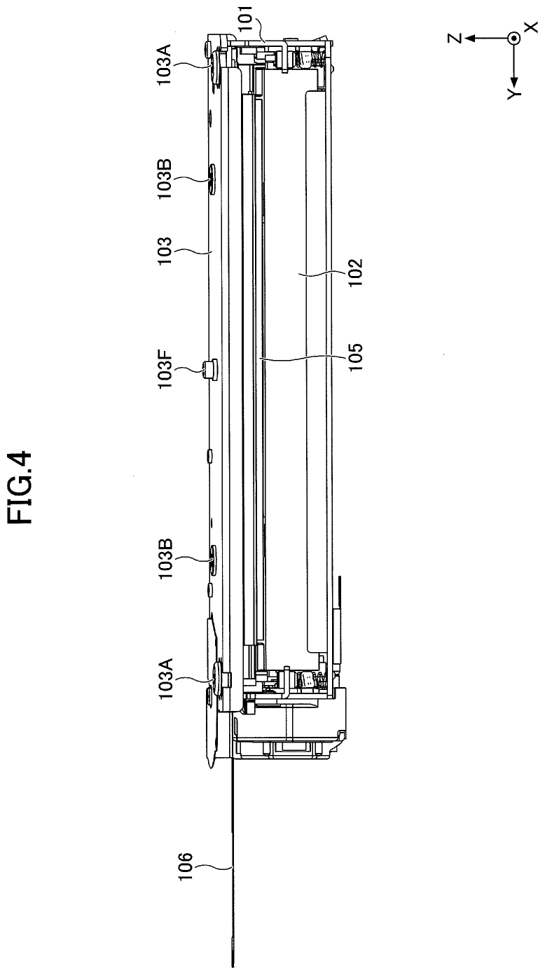

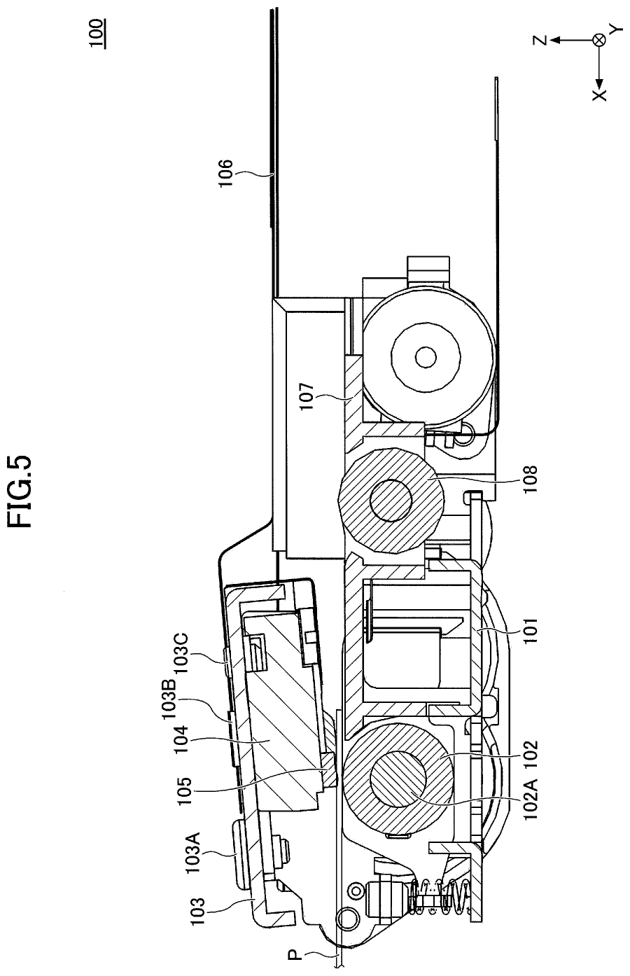

FIG. 1 is a perspective view illustrating an appearance of the thermal printer 100 according to the first embodiment. FIG. 2 is a plan view of the thermal printer 100 according to the first embodiment. FIG. 3 is a side view of the thermal printer 100 according to the first embodiment. FIG. 4 is a front view of the thermal printer 100 according to the first embodiment. FIG. 5 is a cross-sectional view of the thermal printer 100 illustrated in FIG. 1 taken along the line A-A. In the following description, for convenience, a Z-axis direction in the drawing is a vertical direction or an up and down direction, an X-axis direction in the drawing (a conveying direction of a thermal paper P and a transverse direction of a thermal head 105) is a front and rear direction, and a Y-axis direction in the drawing (a direction orthogonal to the conveying direction of the thermal paper P and a longitudinal direction of the thermal head 105) is a horizontal direction or a left and right direction.

The thermal printer 100 illustrated in FIGS. 1 to 5 is an example of an “image forming apparatus” and is what is called a thermal printer that can form an image on the thermal paper P by heating the thermal paper P by heating elements provided in the thermal head 105 in a state that the thermal paper P is pressed against the thermal head 105.

As illustrated in FIGS. 1 to 5, the thermal printer 100 includes a frame 101, a platen roller 102, a support member 103, a plate 104, the thermal head 105, Flexible Printed Circuits (FPC) 106, a paper feed guide 107, and a paper feed roller 108.

The frame 101 is a tray-shaped member formed by processing a metal plate. The frame 101 includes a bottom surface that is approximately rectangular in plan view from above and a left wall and a right wall that are vertically erected along both left and right edges of the bottom surface.

The platen roller 102 is a cylindrical member that extends in the horizontal direction (i.e., in the Y-axis direction in the drawing) between the right wall and the left wall of the frame 101. The platen roller 102 is pivotally supported at both ends of a rotating shaft 102A of the platen roller 102 by bearings 101A attached to the right wall and the left wall of the frame 101. The Platen roller 102 is provided to face the thermal head 105. The platen roller 102 can press a surface of the thermal paper P against the thermal head 105 with the thermal paper P being interposed into a gap between the platen roller 102 and the thermal head 105 (see FIG. 5). The platen roller 102 is rotated by drive of various motors (for example, a stepper motor), so that the thermal paper P can be conveyed in a predetermined conveyance direction (i.e., a positive direction of the X-axis in the drawing). For example, an elastic material such as rubber is used for a roller of the platen roller 102. For example, a relatively hard material such as metal is used for the rotating shaft 102A of the platen roller 102. The platen roller 102 is not limited to a roller that is rotated by drive of a motor, and the platen roller 102 may rotate in accordance with conveyance of the thermal paper P.

The support member 103 is a cover-shaped member having an approximately horizontal flat surface formed by processing a metal plate. The support member 103 is attached to an upper part of the frame 101 such that a part of an inner space of the frame 101 (i.e., a space in which the plate 104 and the thermal head 105 are housed) is closed from above. The plate 104 is screwed to a back surface of the support member 103 by fixing screws 103B passing through the support member 103 from above at substantially central positions of the support member 103 in the X-axis direction in the drawing. Thus, the support member 103 supports the thermal head 105 with the plate 104. The support member 103 is screwed to the frame 101 by fixing screws 103A passing through the support member 103 from above at both ends of the support member 103 in the left and right direction (i.e., the Y-axis direction in the drawing). In particular, in the embodiment, the support member 103 is screwed to the frame 101 by the fixing screws 103A at fixing parts provided at one end in the front and rear direction of the support member 103 (i.e., a positive end of the X-axis in the drawing). This enables a rear portion of the support member 103 behind the fixing parts (i.e., a portion of a negative side of the X-axis in the drawing) to curve upward by adjustment screws 103C provided in the rear portion.

The plate 104 is attached to the back surface of the support member 103. The plate 104 is a flat plate-shaped member having an approximately horizontal flat surface. For example, a relatively hard material such as metal is used for the plate 104.

The thermal head 105 is provided to face the platen roller 102 on a back surface of the plate 104. The thermal head 105 provides multiple heating elements to be side by side in a width direction (i.e., the Y-axis direction in the drawing and the direction orthogonal to the conveying direction of the thermal paper P). A slight gap, which is smaller than the thickness of the thermal paper P, is formed between the thermal head 105 and the platen roller 102. For example, when the thickness of the thermal paper P is 0.25 mm, a gap of 0.15 mm is formed between the thermal head 105 and the platen roller 102. This enables a surface of the thermal paper P to be pressed against the thermal head 105 at an appropriate pressure when the thermal paper P is inserted between the thermal head 105 and the platen roller 102. Heat generation of the multiple heating elements is controlled by a control signal supplied from an external circuit through the FPC 106 in a state that the surface of the thermal paper P is pressed against the thermal head 105, so that the thermal head 105 can form an image on the thermal paper P.

The FPC 106 is a member that connects the thermal head 105 to the external circuit (which is not illustrated) to supply a control signal to the thermal head 105. The FPC 106 is a film-shaped wiring member having a structure in which wires formed of metal films are sandwiched by resin films such as polyimides. The FPC 106 is flexible and can be bent.

The paper feed guide 107 and the paper feed roller 108 are provided in a rear portion of the frame 101. The thermal paper P is placed in the paper feed guide 107. The paper feed roller 108 is rotated to transfer the thermal paper P placed on the paper feed guide 107 into the gap between the platen roller 102 and the thermal head 105.

In the thermal printer 100 configured as described, the thermal paper P is transferred into the gap between the thermal head 105 and the platen roller 102 by the paper feed guide 107 and the paper feed roller 108. As a result, the thermal head 105 and the platen roller 102 interpose the thermal paper P that has been transferred. In this state, a control signal corresponding to print data is input from the external circuit (which is not illustrated) to the thermal head 105 through the FPC 106. The thermal head 105 heats the thermal paper P by multiple heating elements heating in accordance with the input control signal. This causes the thermal head 105 to form an image corresponding to the print data on the thermal paper P.

(Method of Adjusting the Angle of the Thermal Head 105)

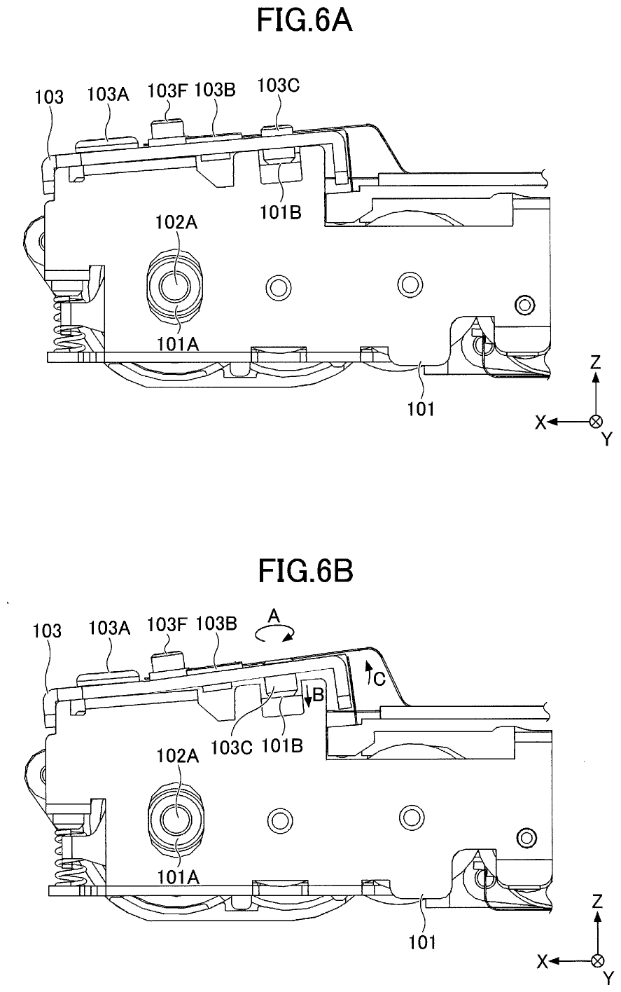

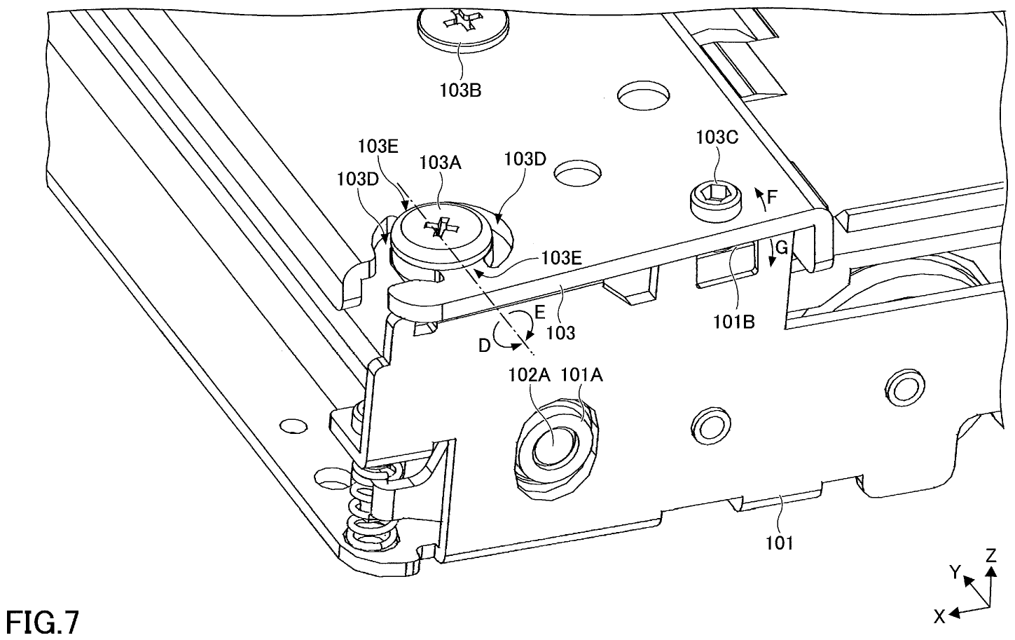

Next, a method of adjusting the angle of the thermal head 105 in the thermal printer 100 will be specifically described with reference to FIGS. 6A, 6B, and 7. FIGS. 6A and 6B are drawings for describing an operation of adjusting the angle of a thermal head in the thermal printer according to the first embodiment. FIG. 6A illustrates a state before the angle of the thermal head 105 is adjusted, and FIG. 6B illustrates a state after the angle of the thermal head 105 has been adjusted. In practice, the angle of the thermal head 105 is adjusted very slightly, but FIG. 6B illustrates the angle of the thermal head 105 that is significantly changed from the angle of the thermal head 105 in FIG. 6A for ease of understanding.

As illustrated in FIGS. 6A and 6B, the support member 103 is screwed to the upper part of the frame 101 by the fixing screw 103A at the fixing part provided at one end in the front and rear direction (i.e., the positive end of the X-axis in the drawing) of the support member 103.

With respect to the above, the rear portion of the support member 103 behind the fixing screw 103A is not fixed to the frame 101. However, an adjustment part to which an adjustment screw 103C is attached, is provided in the rear portion. The adjustment screw 103C is provided in the adjustment part so that the adjustment screw 103C passes through the adjustment part of the support member 103 from above and a tip surface of the adjustment screw 103C is in contact with a contact surface 101B formed on the upper part of the frame 101. The amount of protrusion of the adjustment screw 103C from the back surface of the support member 103 can be adjusted by the rotation of the adjustment screw 103C.

For example, from the state illustrated in FIG. 6A, by rotating the adjustment screw 103C clockwise (i.e., in a direction of the arrow A in the drawing) from above (i.e., from the positive side of the Z-axis in the drawing), the amount of downward protrusion of the adjustment screw 103C is increased (i.e., in a direction of the arrow B in the drawing), so that the adjustment part is gradually pushed up, and the rear part of the support member 103 behind the fixing screw 103A gradually curves upward (i.e., in a direction of the arrow C in the drawing), as illustrated in FIG. 6B. As a result, a tilt of the plate 104 and the thermal head 105 held on the back surface of the support member 103 is changed upward to adjust the angle of the plate 104 and the thermal head 105.

Conversely, from the state illustrated in FIG. 6B, by rotating the adjustment screw 103C counterclockwise (i.e., in a direction opposite to the arrow A in the drawing) from above (i.e., from the positive side of the Z-axis in the drawing), the amount of downward protrusion of the adjustment screw 103C is decreased (i.e., in a direction opposite to the arrow B in the drawing), so that the adjustment part is gradually released from being pushed up, and the rear part of the support member 103 behind the fixing screw 103A is gradually released from curving upward (i.e., in a direction opposite to the arrow C in the drawing). As a result, a tilt of the plate 104 and the thermal head 105 held on the back surface of the support member 103 is changed downward to adjust the angle of the plate 104 and the thermal head 105.

(Configuration of the Fixing Part of the Support Member 103)

FIG. 7 is a partially enlarged view of a part screwed by the fixing screw 103A (i.e., the fixing part) in the thermal printer 100 according to the first embodiment. As illustrated in FIG. 7, in the fixing part of the support member 103, opening portions 103D (examples of a “processed portion”) having shapes curved along the outer peripheral edge of the fixing screw 103A are formed at the front and the rear of the fixing screw 103A. Additionally, in the fixing part of the support member 103, shaft portions 103E connected to the fixing screw 103A are formed at the left and the right of the fixing screw 103A (i.e., at portions other than the opening portions 103D). This enables the support member 103 to be rotated with the shaft portion 103E being twisted.

According to the present configuration, when the height is adjusted by the adjustment screw 103C, the support member 103 is rotated upward (in a direction of the arrow F in the drawing) or downward (in a direction of the arrow G in the drawing) using the shaft portion 103E as a rotating axis with the shaft portion 103E being twisted in a rotating direction (in a direction of the arrow D or the arrow E in the drawing) without being bent and deformed as a whole. As a result, a tilt of the plate 104 and the thermal head 105 held on the back surface of the support member 103 is changed upward (in the direction of the arrow F in the drawing) or downward (in a direction of the arrow G in the drawing) so that the angle of the plate 104 and the thermal head 105 is adjusted. That is, according to the present configuration, an occurrence of distortion or the like in components (e.g., the support member 103, the plate 104, the thermal head 105, etc.) can be suppressed because the overall deformation of the support member 103 can be suppressed.

In the embodiment, the opening portion 103D and the shaft portion 103E are provided in the fixing part of the support member 103, but the opening portion 103D and the shaft portion 103E may not be provided. In this case, when the height of the support member 103 is adjusted by the adjustment screw 103C, the rear portion of the support member 103 behind the fixing screw 103A is bent and deformed as a whole. As a result, a tilt of the plate 104 and the thermal head 105 held on the back surface of the support member 103 is changed upward (in the direction of the arrow F in the drawing) or downward (in the direction of the arrow G in the drawing), so that the angle of the plate 104 and the thermal head 105 is adjusted.

The opening portion 103D may be a portion that is formed at least around or near the fixing screw 103A and that contributes to partial deformation of the support member 103 (i.e., that relatively reduces the torsional rigidity around the fixing screw 103A). A shape and a position of the opening portion 103D are not limited to the embodiment described above.

As the “processed portion”, instead of the opening portion 103D, a recess may be formed around the fixing screw 103A in the support member 103 to partially reduce the thickness of a plate around the fixing screw 103A and relatively reduce the torsional rigidity around the fixing screw 103A.

As described above, without using a configuration for rotating the thermal head 105, the thermal printer 100 according to the first embodiment can adjust the angle of the thermal head 105 only by adjusting the amount of protrusion of the adjustment screw 103C to adjust the amount of bend of the support member 103. Therefore, according to the thermal printer 100 according to the first embodiment, the angle adjustment of the thermal head 105 can be achieved by a relatively simple configuration.

In the thermal printer 100 according to the first embodiment, a “supporting unit” corresponds to the support member 103, a “fixing unit” corresponds to the fixing screw 103A, an “adjuster” corresponds to the adjustment screw 103C, and an “adjustment part” in which the height is adjusted by the adjuster corresponds to a part to which the adjustment screw 103C is attached in the support member 103.

### Second Embodiment

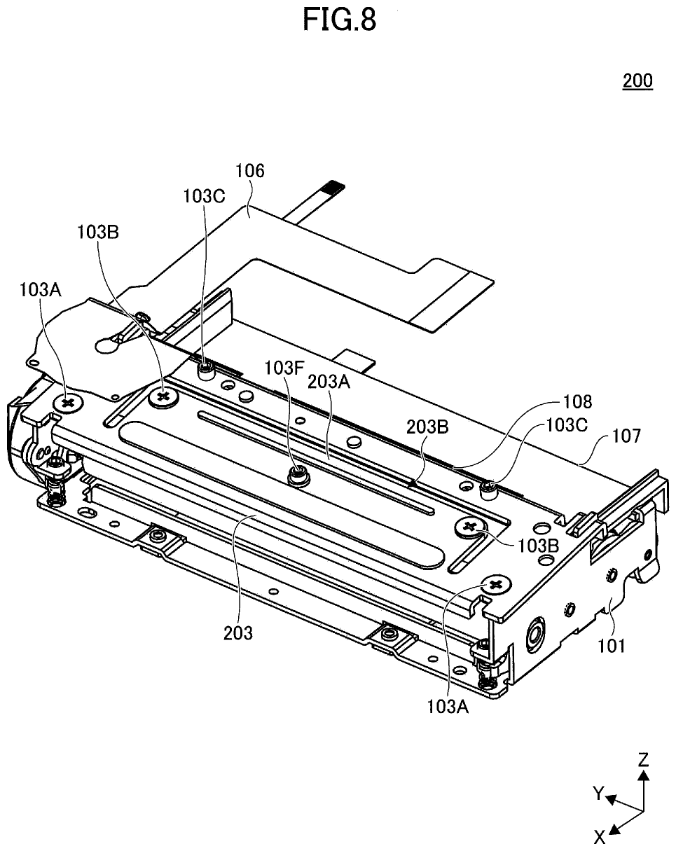

Next, a second embodiment will be described with reference to FIGS. 8 to 12.

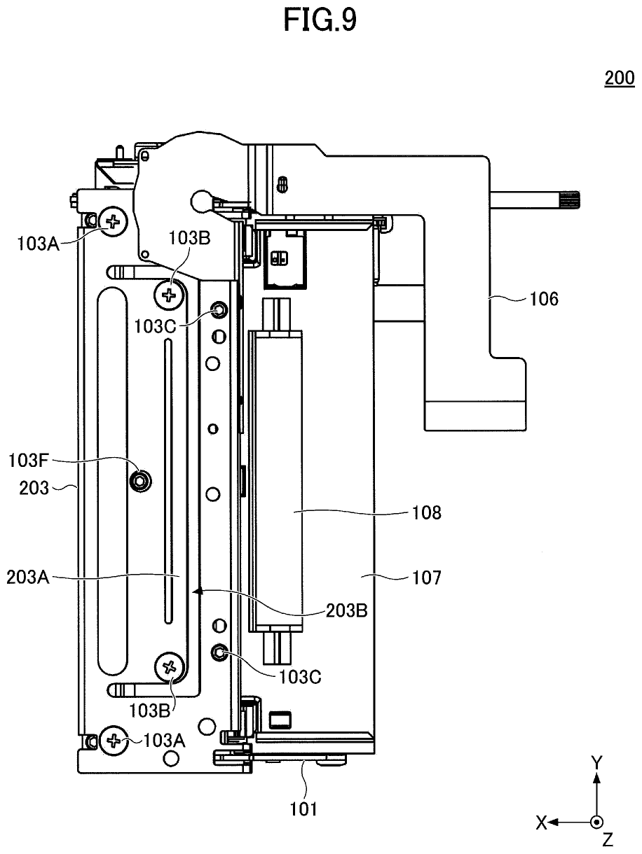

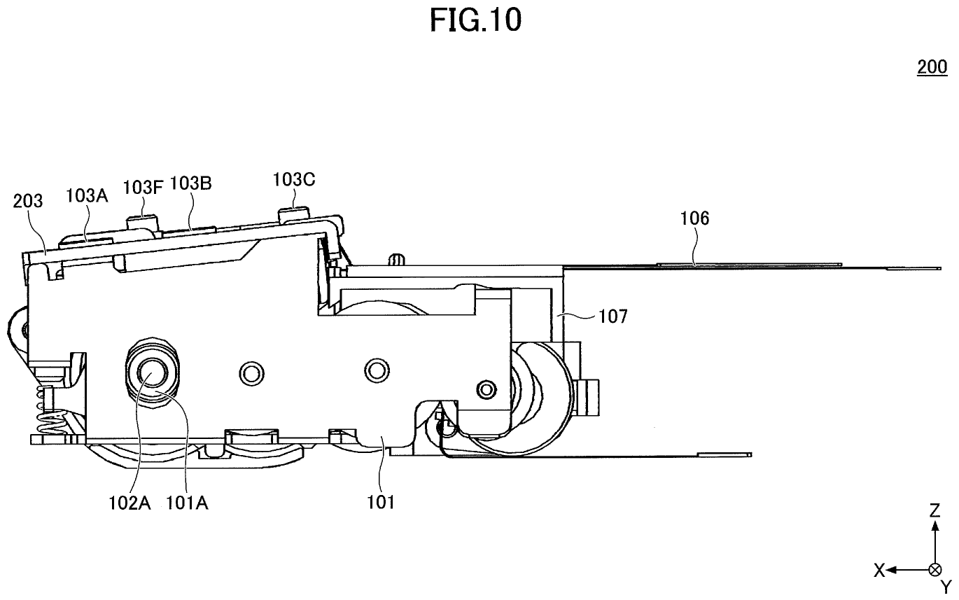

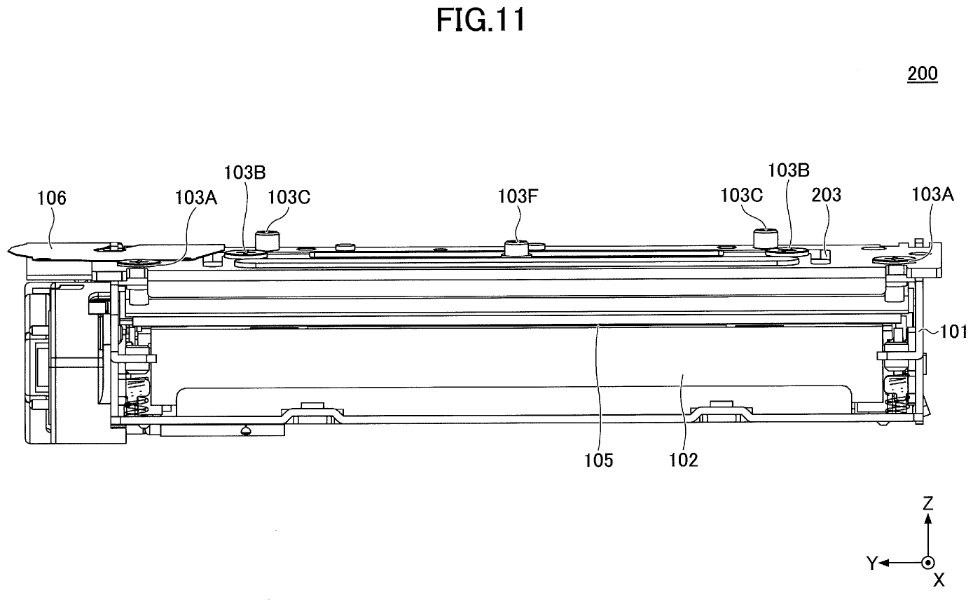

FIG. 8 is a perspective view illustrating an appearance of a thermal printer 200 according to the second embodiment. FIG. 9 is a plan view of the thermal printer 200 according to the second embodiment. FIG. 10 is a side view of the thermal printer 200 according to the second embodiment. FIG. 11 is a front view of the thermal printer 200 according to the second embodiment.

In the following, with respect to the thermal printer 200 according to the second embodiment, changes from the thermal printer 100 according to the first embodiment will be mainly described. Specifically, the thermal printer 200 according to the second embodiment includes a support member 203 instead of the support member 103, and accordingly, a method of adjusting the angle of the thermal head 105 is changed from the method of the thermal printer 100 according to the first embodiment. In the following description, components similar to the components of the thermal printer 100 according to the first embodiment (that may include a slight change in a shape) are referred by the same reference numerals as in the first embodiment, and the detailed description will not be repeated.

(Support Member 203)

A tongue portion 203A is formed in the support member 203 approximately at the center of the support member 203 in the front and rear direction (in the X-axis direction in the drawing). The tongue portion 203A is a generally rectangular shape in which the left and right direction (the Y-axis direction in the drawing) is the longitudinal direction in plan view from above. A cutout part 203B that is cut out in a groove shape along a portion of an outer peripheral edge of the tongue portion 203A (both left and right short sides and a long side of the negative side of the X-axis) is provided to form the tongue portion 203A in the support member 203. In the tongue portion 203A, the long side of the positive side of the X-axis is a fixed end, and the long side of the negative side of the X-axis is a free end, so that the tongue portion 203A can be bent in the vertical direction.

The support member 203 is screwed to the frame 101 at both ends of the support member 203 in the left and right direction (i.e., the Y-axis direction in the drawing) by the fixing screws 103A passing through the support member 203 from above. In particular, in the embodiment, the support member 203 is screwed to the frame 101 by the fixing screws 103A at fixing parts provided at one end (i.e., at the positive end of the X-axis in the drawing) in the front and rear direction (i.e., the X-axis in the drawing).

The plate 104 and the thermal head 105 are provided on the back surface of the support member 203, and the thermal head 105 is attached to the back surface of the plate 104. The plate 104 is screwed to the tongue portion 203A of the support member 203 by a fixing screw 103B passing through the tongue portion 203A from above. This enables the support member 203 to support the thermal head 105 with the plate 104, and enables the support member 203 to change the angle of the plate 104 and the thermal head 105 with the tongue portion 203A being bent in the vertical direction.

The adjustment screw 103C is attached to the other end (the negative end of the X-axis in the drawing) of the support member 203 in the front and rear direction (i.e., the X-axis in the drawing). The adjustment screw 103C is attached to the support member 203 such that the adjustment screw 103C passes through the support member 203 from above and a tip surface of the adjustment screw 103C is in contact with an upper surface of the plate 104. The amount of protrusion of the adjustment screw 103C from the back surface of the support member 203 can be adjusted by the rotation of the adjustment screw 103C. The thermal printer 200 in the embodiment can adjust the angle of the plate 104 and the thermal head 105 by adjusting the amount of protrusion of the adjustment screw 103C.

(Method of Adjusting the Angle of the Thermal Head 105)

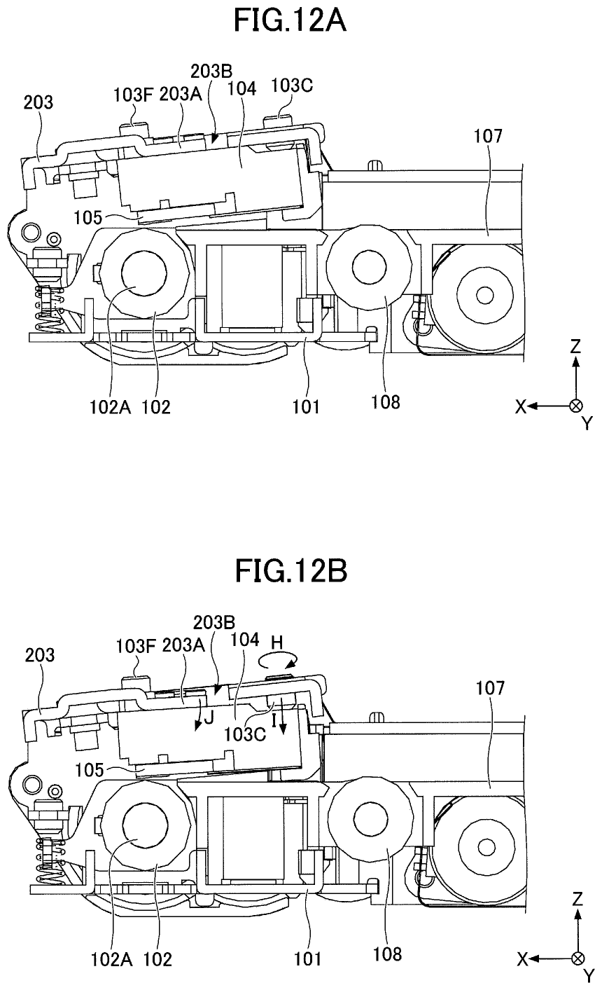

Next, a method of adjusting the angle of the thermal head 105 in the thermal printer 200 will be specifically described with reference to FIGS. 12A and 12B. FIGS. 12A and 12B are drawings for describing an operation of adjusting the angle of the thermal head 105 in the thermal printer 200 according to the second embodiment. FIG. 12A illustrates a state before the angle of the thermal head 105 is adjusted, and FIG. 12B illustrates a state after the angle of the thermal head 105 has been adjusted. FIG. 12B illustrates the angle of the thermal head 105 that is significantly changed from the angle of the thermal head 105 in FIG. 12A for ease of understanding.

As illustrated in FIGS. 12A and 12B, the plate 104 and the thermal head 105 are screwed to the tongue portion 203A of the support member 203. Thus, the angle of the plate 104 and thermal head 105 is changed with the tongue portion 203A being bent in the vertical direction.

As illustrated in FIGS. 12A and 12B, the adjustment screw 103C is attached to the other end (i.e., the negative end of the X-axis in the drawing) of the support member 203 in the front and rear direction (i.e., the direction of the X-axis in the drawing). The adjustment screw 103C is provided in the support member 203 so that the adjustment screw 103C passes through the support member 203 from above and a tip surface of the adjustment screw 103C is in contact with an upper surface of the plate 104 fixed to the tongue portion 203A of the support member 203. The amount of protrusion of the adjustment screw 103C from the back surface of the support member 203 can be adjusted by the rotation of the adjustment screw 103C. The thermal printer 200 in the embodiment can adjust the angle of the plate 104 and the thermal head 105 by adjusting the amount of protrusion of the adjustment screw 103C.

For example, from the state illustrated in FIG. 12A, by rotating the adjustment screw 103C clockwise (i.e., in a direction of the arrow H in the drawing) from above (i.e., from the positive side of the Z-axis in the drawing), the amount of downward protrusion of the adjustment screw 103C is gradually increased (i.e., in a direction of the arrow I in the drawing), so that the plate 104 is gradually preloaded downward, as illustrated in FIG. 12B. The plate 104 is fixed to the tongue portion 203A that is flexible in the vertical direction, so that the plate 104 itself can be tilted downward with the tongue portion 203A being bent downward (i.e., in a direction of the arrow J in the drawing). As a result, a tilt of the plate 104 and the thermal head 105 held on the tongue portion 203A of the support member 203 is changed downward to adjust the angle of the plate 104 and the thermal head 105.

Conversely, from the state illustrated in FIG. 12B, by rotating the adjustment screw 103C counterclockwise (i.e., in a direction opposite to the arrow H in the drawing) from above (i.e., from the positive side of the Z-axis in the drawing), the amount of downward protrusion of the adjustment screw 103C is gradually decreased (i.e., in a direction opposite to the arrow I in the drawing), so that the plate 104 is gradually released from being preloaded downward. At this time, the tongue portion 203A is gradually released from being bent downward (i.e., in a direction opposite to the arrow J in the drawing), and the plate 104 is gradually released from being tilted downward. As a result, a tilt of the plate 104 and the thermal head 105 held on the tongue portion 203A of the support member 203 is changed upward to adjust the angle of the plate 104 and the thermal head 105.

As described above, the thermal printer 200 according to the second embodiment can adjust the angle of the thermal head 105 only by adjusting the amount of protrusion of the adjustment screw 103C to adjust the amount of bend of the tongue portion 203A in the support member 203 without using a configuration for rotating the thermal head 105. Therefore, in the thermal printer 200 according to the second embodiment, the angle adjustment of the thermal head 105 can be achieved by a relatively simple configuration.

In particular, the thermal printer 200 according to the second embodiment can adjust the angle of the plate 104 and the thermal head 105 and can reduce the influence (e.g., the distortion) on another part that is caused by adjusting the angle, because the thermal printer 200 can bend only the tongue portion 203A without bending an entirety of the support member 203.

Additionally, the thermal printer 200 according to the second embodiment does not need to provide what is called an escape space above the support member 203 when the thermal printer 200 is mounted in a housing or the like for example, because the height of the entirety of the support member 203 is fixed and the angle of the thermal head 105 is adjusted by adjusting the amount of downward bend of the tongue portion 203A, and thus space restriction in the housing or the like can be reduced.

Further, the thermal printer 200 according to the second embodiment can adjust the angle of the thermal head 105 with respect to the support member 203 without attaching the support member 203 to the frame 101. Thus, the thermal printer 200 according to the second embodiment can adjust the angle of the thermal head 105 with high accuracy without being affected by, for example, parts accuracy of the frame 101. Also, for example, when the angle of the thermal head 105 is measured, a measurement position is not restricted by the frame 101. That is, it is not necessary to provide a special structure for avoiding interference with the frame 101 to measure the angle of the thermal head 105.

In the thermal printer 200 according to the second embodiment, the “supporting unit” corresponds to the support member 203, the “fixing unit” corresponds to the fixing screw 103A, and the “adjuster” corresponds to the adjustment screw 103C, and the “adjustment part” in which the height is adjusted by the adjuster and a “flexible portion” that can be partially bent, correspond to the tongue portion 203A.

### Third Embodiment

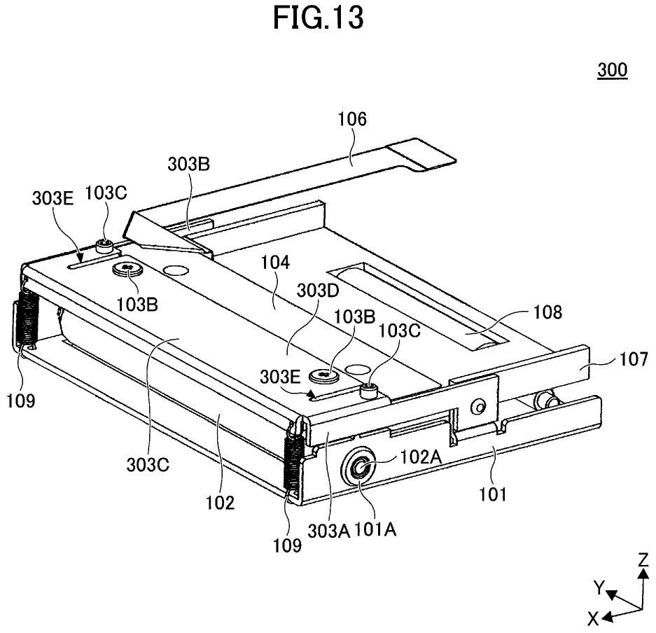

Next, a third embodiment will be described with reference to FIGS. 13 to 17.

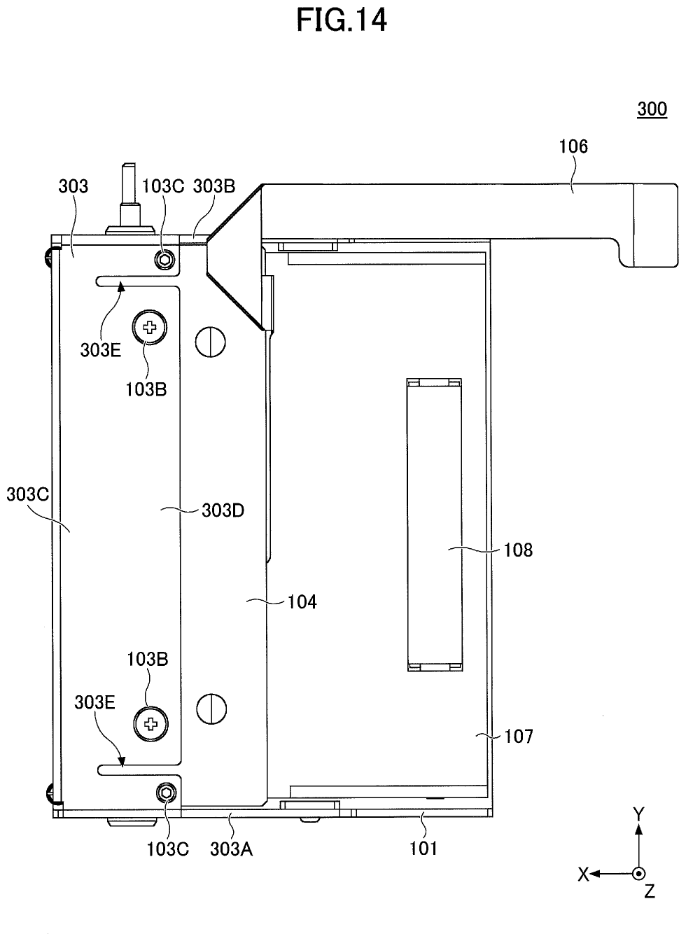

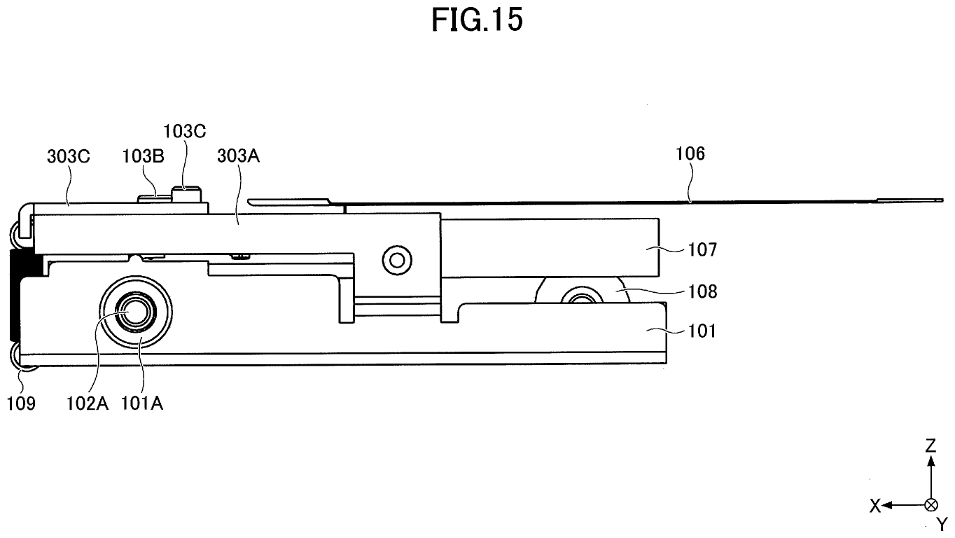

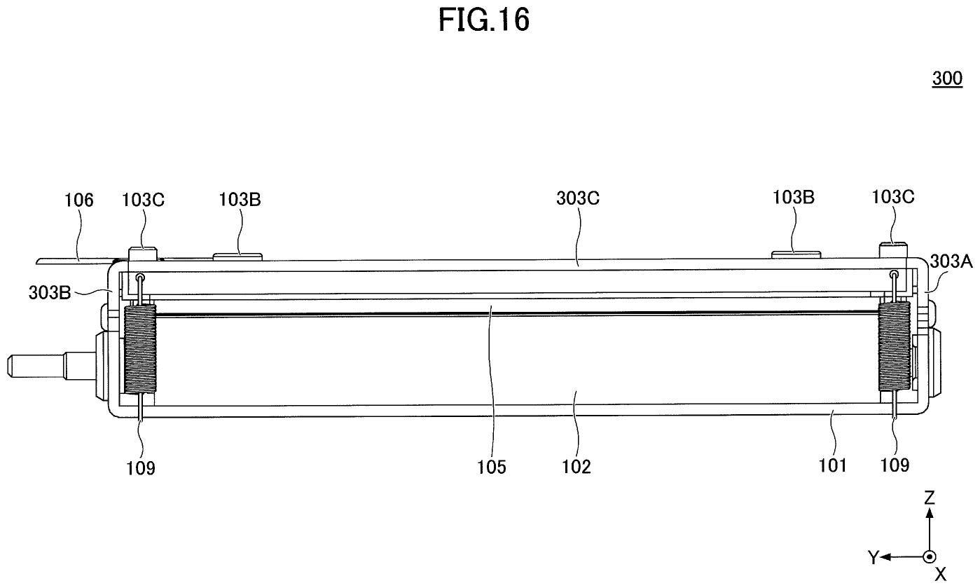

FIG. 13 is a perspective view illustrating an appearance of a thermal printer 300 according to the third embodiment. FIG. 14 is a plan view of the thermal printer 300 according to the third embodiment. FIG. 15 is a side view of the thermal printer 300 according to the third embodiment. FIG. 16 is a front view of the thermal printer 300 according to the third embodiment.

In the following, with respect to the thermal printer 300 according to the third embodiment, changes from the thermal printer 100 according to the first embodiment will be mainly described. Specifically, the thermal printer 300 according to the third embodiment includes a support member 303 instead of the support member 103, and the support member 303 is configured to be rotatable with respect to the frame 101. Accordingly, a method for adjusting the angle of the thermal head 105 is changed from the method of the thermal printer 100 according to the first embodiment. In the following description, components similar to the components of the thermal printer 100 according to the first embodiment (that may include a slight change in a shape) are referred by the same reference numerals as in the first embodiment, and the detailed description will not be repeated.

(Support Member 303)

The support member 303 is rotatable in the vertical direction (i.e., the Z-axis direction in the drawing) with respect to the frame 101. Specifically, the support member 303 includes two left and right arms 303A and 303B and a connection 303C. The two anus 303A and 303B are parts extending from the proximity to the center of the frame 101 in the front and rear direction (i.e., the X-axis direction in the drawing), in the conveying direction of the thermal paper P (i.e., the positive direction of the X-axis in the drawing) along upper edges of the side walls of the frame 101. The two arms 303A and 303B are thin and long, flat plate-shaped and are erected so that surfaces of the two arms 303A and 303B are approximately vertical and are in an approximately the same plane as surfaces of the side walls of the frame 101. The two arms 303A and 303B are connected to each other at tips of the two arms 303A and 303B by the connection 303C that is a flat plate having an approximately horizontal flat surface. The plate 104 and the thermal head 105 are attached to a bottom surface of the connection 303C. The two arms 303A and 303B are pivotally supported by the side walls of the frame 101 at ends of the two arms 303A and 303B. Thus, the support member 303 is rotatable in the vertical direction (i.e., the Z-axis direction in the drawing) with respect to the frame 101 using the ends of the two arms 303A and 303B as rotational axes with supporting the plate 104 and the thermal head 105.

A tongue portion 303D is formed in the connection 303C of the support member 303 at the rear in the front and rear direction (i.e., the negative side of the X-axis in the drawing). The tongue portion 303D is a generally rectangular shape in which the left and right direction (i.e., the Y-axis direction in the drawing) is the longitudinal direction in plan view from above. Cutout parts 303E that are cut out in a groove along left and right short sides of the connection 303C are provided to form the tongue portion 303D in the connection 303C. In the tongue portion 303D, a long side of the positive side of the X-axis is a fixed end, and the long side of the negative side of the X-axis is a free end, so that the tongue portion 303D can be bent in the vertical direction.

The plate 104 and the thermal head 105 are provided on the back surface of the connection 303C, and the thermal head 105 is fixed to the back side of the plate 104. The plate 104 is screwed to the tongue portion 303D of the connection 303C by the fixing screw 103B passing through the tongue portion 303D from above. Thus, the connection 303C can support the thermal head 105 with the plate 104 and can change the angle of the plate 104 and the thermal head 105 with the tongue portion 303D being bent in the vertical direction.

The adjustment screws 103C are attached to the connection 303C at both outer sides of the tongue portion 303D in the left and right direction of the connection 303C (i.e., the Y-axis direction in the drawing). The adjustment screw 103C passes through the connection 303C from above and is attached to the connection 303C such that a tip surface of the adjustment screw 103C is in contact with the upper surface of the plate 104. The amount of protrusion of the adjustment screw 103C from the back surface of the connection 303C can be adjusted by the rotation of the adjustment screw 103C. The thermal printer 300 in the embodiment can adjust the angle of the plate 104 and the thermal head 105 by adjusting the amount of protrusion of the adjustment screw 103C.

The support member 303 maintains a state in which the frame 101 is closed by pressure springs 109. One end of the pressure spring 109 is hooked to a front portion of the support member 303 and the other end of the pressure spring 109 is hooked to the frame 101. Thus, the pressure spring 109 preloads the support member 303 downward and toward the frame 101 to maintain the support member 303 being closed. In a state in which the support member 303 is closed, a gap size between the thermal head 105 and the platen roller 102 is maintained to be appropriate.

(Method of Adjusting the Angle of the Thermal Head 105)

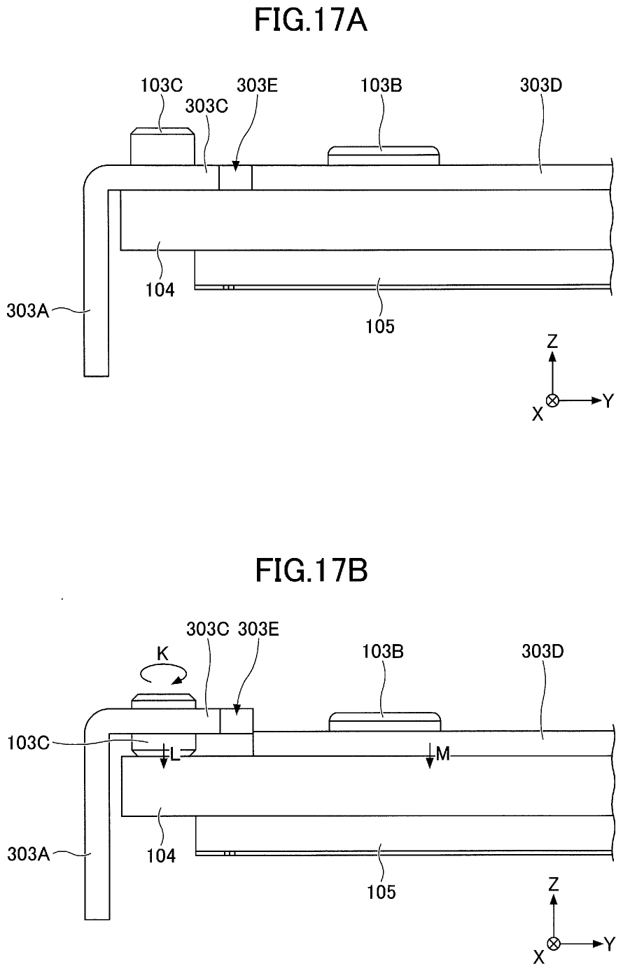

Next, a method of adjusting the angle of the thermal head 105 in the thermal printer 300 will be specifically described with reference to FIGS. 17A and 17B. FIGS. 17A and 17B are drawings for describing an operation of adjusting the angle of the thermal head 105 in the thermal printer 300 according to the third embodiment. FIG. 17A illustrates a state before the angle of the thermal head 105 is adjusted and FIG. 17B illustrates a state after the angle of the thermal head 105 has been adjusted. FIGS. 17A and 17B illustrate the support member 303, the plate 104, and the thermal head 105 from the rear side (i.e., the negative side of the X-axis in the drawing), and does not illustrate other components, for ease of understanding. FIG. 17B illustrates the angle of the thermal head 105 that is significantly changed from the angle of the thermal head 105 in FIG. 17A for ease of understanding.

As illustrated in FIGS. 17A and 17B, the plate 104 and the thermal head 105 are screwed to the tongue portion 303D of the connection 303C. Thus, the angle of the plate 104 and thermal head 105 is changed with the tongue portion 303D being bent in the vertical direction.

As illustrated in FIGS. 17A and 17B, the adjustment screws 103C are attached to both outer sides of the tongue portion 303D in the left and right direction of the connection 303C (i.e., the Y-axis direction in the drawing). The adjustment screw 103C is provided in the connection 303C such that the adjustment screw 103C passes through the connection 303C from above and the tip surface of the adjustment screw 103C is in contact with the upper surface of the plate 104 fixed to the tongue portion 303D of the connection 303C. The amount of protrusion of the adjustment screw 103C from the back surface of the connection 303C can be adjusted by the rotation of the adjustment screw 103C. The thermal printer 300 in the embodiment can adjust the angle of the plate 104 and the thermal head 105 by adjusting the amount of protrusion of the adjustment screw 103C.

For example, from the state illustrated in FIG. 17A, by rotating the adjustment screw 103C clockwise (i.e., in a direction of the arrow K in the drawing) from above (i.e., from the positive side of the Z-axis in the drawing), the amount of downward protrusion of the adjustment screw 103C is gradually increased (i.e., in a direction of the arrow L in the drawing), so that the plate 104 is gradually preloaded downward, as illustrated in FIG. 17B. The plate 104 is fixed to the tongue portion 303D that is flexible in the vertical direction, so that the plate 104 itself can be tilted downward with the tongue portion 303D being bent downward (i.e., in a direction of the arrow M in the drawing). As a result, a tilt of the plate 104 and the thermal head 105 held on the tongue portion 303D of the connection 303C is changed downward to adjust the angle of the plate 104 and the thermal head 105.

Conversely, from the state illustrated in FIG. 17B, by rotating the adjustment screw 103C counterclockwise (i.e., in a direction opposite to the arrow K in the drawing) from above (i.e., from the positive side of the Z-axis in the drawing), the amount of downward protrusion of the adjustment screw 103C is gradually decreased (i.e., in a direction opposite to the arrow L in the drawing), so that the plate 104 is gradually released from being preloaded downward. At this time, the tongue portion 303D is gradually released from being bent downward (i.e., in a direction opposite to the arrow M in the drawing), and the plate 104 is gradually released from being tilted downward. As a result, a tilt of the plate 104 and the thermal head 105 held on the tongue portion 303D of the connection 303C is changed upward to adjust the angle of the plate 104 and the thermal head 105.

As described above, with a configuration in which the thermal head 105 is rotatable with respect to the frame 101, the thermal printer 300 according to the third embodiment can adjust the angle of the thermal head 105 with respect to the support member 303 by adjusting the amount of protrusion of the adjustment screw 103C to adjust the amount of bend of the tongue portion 303D in the support member 303. Therefore, according to the thermal printer 300 according to the third embodiment, the angle adjustment of the thermal head 105 can be achieved by a relatively simple configuration.

In particular, the thermal printer 300 according to the third embodiment can adjust the angle of the plate 104 and the thermal head 105 and can reduce the influence (e.g., the distortion) on another part that is caused by adjusting the angle because the thermal printer 300 can bend only the tongue portion 303D without bending an entirety of the support member 303.

Additionally, the thermal printer 300 according to the third embodiment does not need to provide what is called an escape space above the support member 303 when the thermal printer 300 is mounted in the housing or the like for example, because the height of the entirety of the support member 303 is fixed and the angle of the thermal head 105 is adjusted by adjusting the amount of downward bend of the tongue portion 303D, and thus space restriction in the housing or the like can be reduced.

Further, the thermal printer 300 according to the third embodiment can adjust the angle of the thermal head 105 to the support member 303 without attaching the support member 303 to the frame 101. Thus, the thermal printer 300 according to the third embodiment can adjust the angle of the thermal head 105 with high accuracy without being affected by, for example, parts accuracy of the frame 101. Also, for example, when the angle of the thermal head 105 is measured, a measurement position is not restricted by the frame 101. That is, it is not necessary to provide a special structure for avoiding interference with the frame 101 to measure the angle of the thermal head 105.

In the thermal printer 300 according to the third embodiment, the “supporting unit” corresponds to the support member 303, the “adjuster” corresponds to the adjustment screw 103C, and the “adjustment part” of which the height is adjusted by the adjuster and a “flexible portion” that can be partially bent, correspond to the tongue portion 303D.

(Method of Adjusting a Curvature of the Thermal Head 105)

In the following, a curvature adjustment mechanism of the thermal head 105 applied to the thermal printer 100 according to the first embodiment will be described. The curvature adjustment mechanism is also applied to the thermal printer 200 according to the second embodiment. Although the curvature adjustment mechanism is not applied to the thermal printer 300 according to the third embodiment, the curvature adjustment mechanism can be applied to the thermal printer 300.

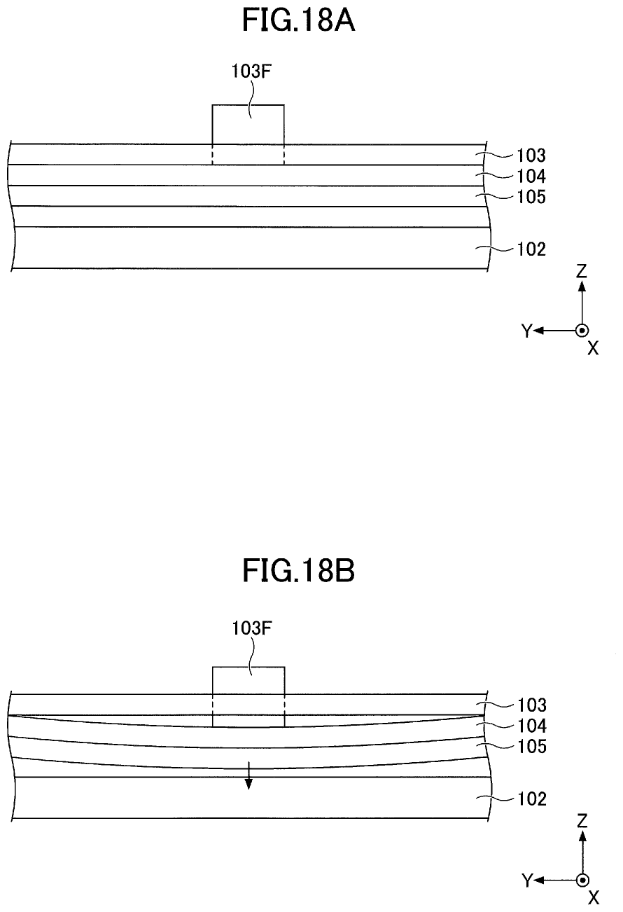

FIGS. 18A and 18B are drawings for schematically describing an operation of adjusting the angle of the thermal head in the thermal printer 100 according to the first embodiment. FIG. 18A illustrates a state in which the curvature of the thermal head 105 is not adjusted. FIG. 18B illustrates a state in which the curvature of the thermal head 105 is adjusted.

In the thermal printer 100 according to the first embodiment, the platen roller 102 is relatively long in the left and right direction (i.e., the Y-axis direction in the drawing) and only both ends of the platen roller 102 are supported by the frame 101. Therefore, when the thermal head 105 is pressed against the platen roller 102, a middle portion of the platen roller 102 in the left and right direction (i.e., the Y-axis direction in the drawing) may be bent downward. In this case, a press force of the thermal head 105 is reduced in the middle portion of the thermal paper P in the left and right direction (i.e., the Y-axis direction in the drawing), and printing density may become low.

Thus, as illustrated in FIG. 18B, the thermal printer 100 according to the first embodiment presses down the middle portion of the thermal head 105 along with the plate 104 by an adjustment screw 103F (i.e., an example of the “second adjuster”) provided in the middle portion of the support member 103 in the left and right direction (i.e., the Y-axis direction in the drawing), so that the thermal printer 100 can curve the middle portion of the thermal head 105 downward. This can compensate for a decrease in the press force of the thermal head 105 caused by the platen roller 102 being bent downward, and can avoid an occurrence in which the printing density decreases in the middle portion of the thermal paper P in the left and right direction (i.e., the Y-axis direction in the drawing).

One embodiment of the present invention has been described in detail above, but the present invention is not limited to these embodiments, and various modifications or alterations can be made within the scope of the present invention described in the claim.

For example, in the first, second, and third embodiments described above, the adjustment screw 103C may be provided directly in the support members 103, 203, and 303, or may be provided in another component attached to the support members 103, 203, and 303.

For example, in the first embodiment described above, the tip of the adjustment screw 103C may be directly in contact with the frame 101 or may be in contact with another component attached to the frame 101. However, both cases are included in a category of “being butted against the frame” described in the claim.

For example, in the second and third embodiments described above, the tip of the adjustment screw 103C may be directly in contact with the plate 104 or may be in contact with another component attached to the plate 104 (e.g., the thermal head 105, etc.). However, both cases are included in the category of “being butted against the frame” described in the claim.

For example, in the first, second, and third embodiments described above, the support members 103, 203, and 303 made of a single member are equivalent to the “supporting unit”, but a combination of multiple members may be equivalent to the “supporting unit”.

The “supporting unit” is not limited to a means supporting the thermal head directly, but may be a means supporting the thermal head indirectly via another component (e.g., the plate) as described in the embodiments described above.

What is claimed is:

1. An image forming apparatus comprising:
a frame;
a platen roller rotatably supported by the frame;
a thermal head that is provided to face the platen roller; and
a supporting unit that supports the thermal head from above,
wherein the supporting unit includes an adjustment part that can adjust a height of the supporting unit by an adjuster, and the supporting unit can adjust an angle of the thermal head by adjusting the height of the adjustment part by the adjuster with at least a portion of the supporting unit being deformed, and
wherein the supporting unit can adjust the height of the adjustment part by adjusting a protrusion amount of the adjuster with a tip of the adjuster being butted against the frame.

2. The image foiling apparatus as claimed in claim 1, wherein the supporting unit includes a processed portion around a fixing part that fixes the supporting unit to the frame by a fixing unit, the processed portion reducing torsional rigidity around the fixing part.

3. The image foaming apparatus as claimed in claim 2, wherein the fixing part is provided at an end of the supporting unit, the end of the supporting unit being near the thermal head in a direction parallel to a transverse direction of the thermal head.

4. The image forming apparatus as claimed in claim 1,
wherein the adjustment part is a flexible part that can partially bend by a cutout part formed on a portion of the supporting unit, and the thermal head is supported by the flexible part.

5. The image forming apparatus as claimed in claim 4, wherein the flexible part is a tongue shape including a fixed end and a free end, and the cutout part is formed along an outer peripheral edge of the flexible part except the fixed end.

6. The image foaming apparatus as claimed in claim 4, wherein the supporting unit is fixed to the frame at a fixing part by a fixing unit, the fixing part being provided at an end of the supporting unit near the thermal head in a direction parallel to a transverse direction of the thermal head.

7. The image forming apparatus as claimed in claim 4, wherein the supporting unit includes an arm pivotally supported by the frame, and the supporting unit rotatably supports the thermal head with respect to the frame.

8. The image forming apparatus as claimed in claim 1, wherein the supporting unit includes a second adjuster that can adjust curvature of the thermal head, the second adjuster being provided at a middle portion of the supporting unit in a direction parallel to a longitudinal direction of the thermal head.

9. The image forming apparatus as claimed in claim 1, wherein the adjuster is a screw.
